(19) United States
(12) Patent Application Publication
(10) Pub. No.: US 2016/0291910 A1
(43) Pub. Date: Oct. 6, 2016

(54) IMAGE FORMING APPARATUS, IMAGE FORMING SYSTEM, INFORMATION-PROCESSING DEVICE AND IMAGE-FORMING METHOD

(71) Applicant: Konica Minolta, Inc., Tokyo (JP)

(72) Inventor: Yu TANAKA, Tokyo (JP)

(73) Assignee: Konica Minolta, Inc., Tokyo (JP)

(21) Appl. No.: 15/081,389

(22) Filed: Mar. 25, 2016

(30) Foreign Application Priority Data
Mar. 30, 2015 (JP) 2015-068584

(51) Int. Cl. G06F 3/12; G06K 15/16; G06K 15/00; G06F 21/31

(52) U.S. Cl. CPC G06F 3/1271; G06F 21/31; G06F 3/1205; G06F 3/1235; G06F 3/1257; G06F 3/1258; G06K 15/16; G06K 15/404

(57) ABSTRACT

A hardware processor of an image-forming apparatus determines whether or not a user manipulation is generated when a registered job is executing. The hardware processor requests the authentication operation by the user and allows a manipulation portion to execute the authentication operation by the user when determining that a job is the job in which the user manipulation is generated. The hardware processor executes the job when the authentication operation by the user is executed, and waits for the execution of the job when the authentication operation by the user is not executed.

### CROSS REFERENCES TO RELATED APPLICATIONS

The present invention contains subject matter related to Japanese Patent Application JP 2015-068584 filed in the Japanese Patent Office on Mar. 30, 2015, the entire contents of which being incorporated herein by reference.

### BACKGROUND OF THE INVENTION

1. Field of the Invention

The present invention relates to an image-forming apparatus that executes a job based on a previously set content, an image-forming system including the image-forming apparatus, an information-processing device that is connected to the image-forming apparatus and an image-forming method.

2. Description of Related Art

An image-forming apparatus that forms an image on a sheet and outputs it registers any jobs for specifying species of sheet, a number of the sheet(s) to be printed, a print run, a feeding tray, a sheet-ejecting tray and the like and forming an image. When plural users use the image-forming apparatus, the jobs are executed according to an order of the registration.

A user manipulation may be always accompanied when a job is executing. In this case, if the user leaves an installed position of the image-forming apparatus while the image-forming apparatus executes the job generated by the user manipulation, the image-forming process interrupts because the user manipulation is not performed at timing when the user manipulation should be performed.

Therefore, a case where the job has not yet completed may occur when the user returns to get a sheet on which the image as the finished job has been formed.

Moreover, when the user who registers the job generated by the user manipulation is absence and a state where the image-forming processing interrupts continues, it may be impossible for another user to use the image-forming apparatus. When forcibly skipping the interrupted job and executing another job, a manipulation of the image-forming apparatus becomes complicated. For example, a sheet on the way to being processed in a preceding job is temporarily escaped and then it returns to an original position.

Further, a technology has been known such that when the image-forming apparatus receives a job formed by an information-processing device on a network and performs the printing, the image-forming apparatus recognizes that there is quite a physical distance between the information-processing device and the image-forming apparatus so that it waits the printing (see, for example, Japanese Patent Application Publication No. 2008-158646).

### SUMMARY OF THE INVENTION

In the past, however, if any user manipulation is generated when the job is executing, the job interrupts according to the generation of the user manipulation so that it may be impossible to further execute the job.

The present invention addresses the above-described issues. The present invention has an object to provide an image-forming apparatus that can determine a job generation by the user manipulation and can wait the execution of the job, an image-forming system including the image-forming apparatus, an information-processing device that is connected to the image-forming apparatus and an image-forming method.

To achieve at least one of the above-described objects, an image-forming apparatus reflecting one aspect of the present invention is an image-forming apparatus containing a feeder that feeds a sheet, an image-forming portion that forms an image on the sheet fed from the feeder, a fixing portion that fixes the image formed on the sheet by the image-forming portion, a sheet-ejection portion that ejects the sheet on which the image is fixed by the fixing portion, a manipulation portion that executes an authentication operation by a user, and a hardware processor configured to perform the following process: determining whether or not a user manipulation is generated when a job is executing; requesting the authentication operation by the user and allowing the manipulation portion to execute the authentication operation by the user when determining that a job is the job in which the user manipulation is generated; executing the job when the authentication operation by the user is executed; and waiting for the execution of the job when the authentication operation by the user is not executed.

According to embodiments of the present invention, it is desired to provide the image-forming apparatus wherein when the user manipulation is generated while the job is executing, the hardware processor is configured to perform the following process: determining whether or not the user manipulation is generated when the job is executing after the user manipulation is executed; requesting the user authentication operation by the user and allowing the manipulation portion to execute the authentication operation by the user when determining that a job is the job in which the user manipulation is generated; executing the job when the authentication operation by the user is executed; waiting for the execution of the job when the authentication operation by the user is not executed; and avoiding requesting the authentication operation by the user to execute the job when determining that a job is the job in which the user manipulation is not generated.

It is further desired to provide the image-forming apparatus wherein when determining that the number of sheets to be printed, the number being set by the job, is more than the number of sheets which can be fed from the feeder, the hardware processor requests the authentication operation by the user before the execution of the job.

It is additionally desired to provide the image-forming apparatus wherein when determining that the number of sheets to be printed, the number being set by the job, is more than the number of sheets which can be ejected by the sheet-ejection portion, the hardware processor requests the authentication operation by the user before the execution of the job.

It is still further desired to provide the image-forming apparatus further comprising a sheet-inserting portion that inserts a sheet to other sheets which are ejected from the sheet-ejection portion wherein when determining that an inserting job is executed, the hardware processor requests the authentication operation by the user before the execution of the inserting job, the inserting job including printing an inserting sheet, setting the printed inserting sheet in the sheet-inserting portion, printing sheets to which the inserting sheet is inserted, and inserting the inserting sheet to the sheets to which the inserting sheet is inserted.

It is still additionally desired to provide the image-forming apparatus wherein the hardware processor informs the user that the job is executed after the authentication operation by the user when requesting the authentication operation by the user.

Other objects and attainments of the present invention will be become apparent to those skilled in the art upon a reading of the following detailed description when taken in conjunction with the drawing.

### BRIEF DESCRIPTION OF THE DRAWINGS

FIG. 1 is a diagram showing a configuration example of an image-forming apparatus according to an embodiment of this invention;

FIG. 2 is a diagram showing a configuration example of an image-forming system according to an embodiment of this invention;

FIG. 3 is a block diagram showing a control function example of the image-forming apparatus and the image-forming system according to the embodiment of the invention;

FIG. 4 is a flowchart showing an example of a program for executing an authentication operation by a user according to an embodiment of this invention;

FIG. 5 is a flowchart showing an example of operations in an information-processing device according to an embodiment of the invention;

FIG. 6 is an illustration for indicating an example of a user authentication request screen;

FIG. 7 is a flowchart showing an example of operations in an image-forming apparatus according to an embodiment of the invention;

FIG. 8 is an illustration for indicating an example of a user authentication request screen;

FIG. 9 is a flowchart showing another example of operations in an image-forming apparatus according to an embodiment of the invention;

FIG. 10 is an illustration for indicating an example of a user authentication request screen;

FIG. 11 is a flowchart showing an example of operations in an image-forming system according to an embodiment of the invention; and

FIG. 12 is an illustration for indicating an example of a user authentication request screen.

### DESCRIPTION OF THE PREFERRED EMBODIMENTS

The following will describe embodiments of an image-forming apparatus, an image-forming system including the image-forming apparatus, an information-processing device that is connected to the image-forming apparatus and an image-forming method according to the present invention with reference to the drawings. Such description does not limit the technical scope, meaning of terms and the like in Claims.

### <Configuration Example of Image-Forming Apparatus According to Embodiments of Present Invention>

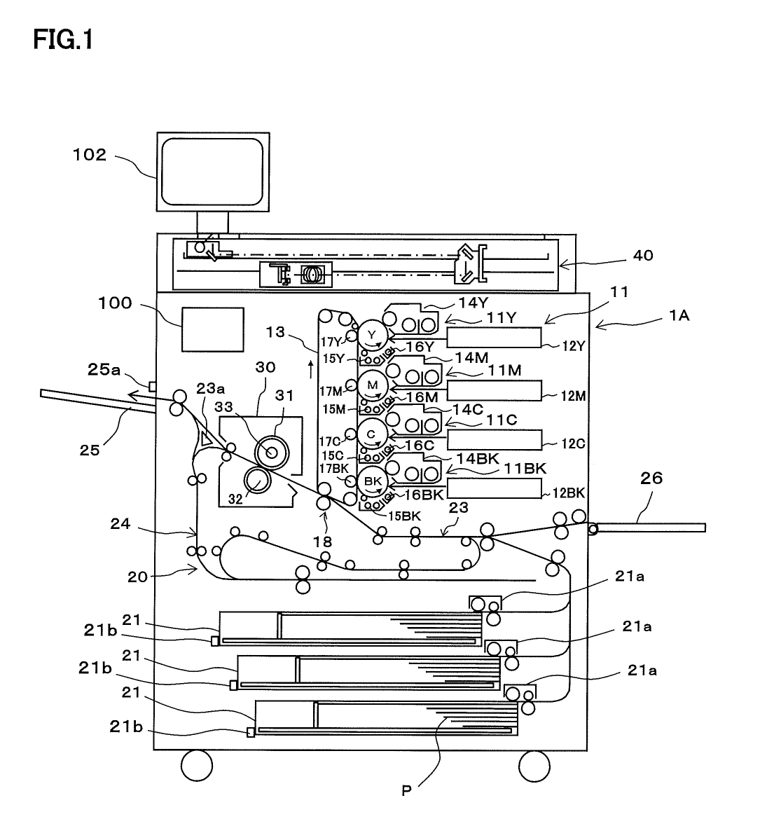

FIG. 1 shows a configuration example of the image-forming apparatus according to an embodiment of this invention. The image-forming apparatus 1A is provided with an image-forming portion 11, a sheet-conveying portion 20, a fixing portion 30 and a document-reading device 40.

The image-forming portion 11 includes an image-forming unit 11Y which forms a yellow (Y) image, an image-forming unit 11M which forms a magenta (M) image, an image-forming unit 11C which forms a cyan (C) image and an image-forming unit 11BK which forms a black (BK) image.

The image-forming unit 11Y contains a photosensitive drum Y, a charging portion 16Y positioned around the photosensitive drum Y, an optical writing portion 12Y, a developing portion 14Y and a drum cleaner 15Y. Similarly, the image-forming unit 11M contains a photosensitive drum M, a charging portion 16M positioned around the photosensitive drum M, an optical writing portion 12M, a developing portion 14M and a drum cleaner 15M. The image-forming unit 11C contains a photosensitive drum C, a charging portion 16C positioned around the photosensitive drum C, an optical writing portion 12C, a developing portion 14C and a drum cleaner 15C. The image-forming unit 11BK contains a photosensitive drum BK, a charging portion 16BK positioned around the photosensitive drum BK, an optical writing portion 12BK, a developing portion 14BK and a drum cleaner 15BK.

The charging portion 16Y charges a static charge uniformly around the surface of the photosensitive drum Y. The optical writing portion 12Y scans and exposes a surface of the photosensitive drum Y to form an electrostatic latent image on the photosensitive drum Y. The developing portion 14Y develops the electrostatic latent image formed on the surface of the photosensitive drum Y by using toner and makes it visible. Thus, a toner image corresponding to the yellow is formed on the photosensitive drum Y.

Similarly, the charging portion 16M charges a static charge uniformly around the surface of the photosensitive drum M. The optical writing portion 12M scans and exposes a surface of the photosensitive drum M to form an electrostatic latent image on the photosensitive drum M. The developing portion 14M develops the electrostatic latent image formed on the surface of the photosensitive drum M by using toner and makes it visible. Thus, a toner image corresponding to the magenta is formed on the photosensitive drum M.

The charging portion 12C charges a static charge uniformly around the surface of the photosensitive drum C. The optical writing portion 12C scans and exposes a surface of the photosensitive drum C to form an electrostatic latent image on the photosensitive drum C. The developing portion 14C develops the electrostatic latent image formed on the surface of the photosensitive drum C by using toner and makes it visible. Thus, a toner image corresponding to the cyan is formed on the photosensitive drum C.

The charging portion 12BK charges a static charge uniformly around the surface of the photosensitive drum BK. The optical writing portion 12BK scans and exposes a surface of the photosensitive drum BK to form an electrostatic latent image on the photosensitive drum BK. The developing portion 14BK develops the electrostatic latent image formed on the surface of the photosensitive drum BK by using toner and makes it visible. Thus, a toner image corresponding to the black is formed on the photosensitive drum BK.

Primary transfer rollers 17Y, 17M, 17C and 17BK transfer the images formed on the photosensitive drums Y, M, C and BK one by one onto predetermined positions of an intermediate transfer belt 13 which is a belt-like intermediate transfer member.

Secondary transfer rollers 18 transfer each color image transferred onto the intermediate transfer belt 13 to the sheet P, which is conveyed by the sheet-conveying portion 20, at a predetermined timing.

The sheet-conveying portion 20 includes feeding trays, in this embodiment, plural feeding trays 21, containing the sheets P and feeding portions 21a by which a sheet P contained in each of the feeding trays 21 is fed. The sheet-conveying portion 20 also includes a main sheet-conveying route 23 on which the sheet P fed from any of the feeding trays 21 is conveyed, a reverse sheet-conveying route 24 in which the sheet P is reversed and a sheet-ejecting tray 25 from which the sheet P is ejected.

The sheet-conveying route from the feeding trays 21 to the sheet-ejecting tray 25 as a sheet-ejection device constitutes the main sheet-conveying route 23. When using an external feeding tray 26, which is a feeding device that is called as “a manual feed tray”, the sheet-conveying route from the external feeding tray 26 comes together the main sheet-conveying route 23 at an upstream side of a confluent portion of the main sheet-conveying route 23 and the reverse sheet-conveying route 24.

In the sheet-conveying portion 20, the reverse sheet-conveying route 24 branches from the main sheet-conveying route 23 at a downstream side of the fixing portion 30. A change-over gate 23a is provided at a branch portion of the main sheet-conveying route 23 and the reverse sheet-conveying route 24.

In the image-forming apparatus 1A, an image is formed on an upward surface of the sheet P conveyed on the main sheet-conveying route 23 and passed through the secondary transfer portion 18 and the fixing portion 30. When the images are formed on both surfaces of the sheet P, the sheet P, in which the image has been formed on one upward surface, is conveyed from the main sheet-conveying route 23 to the reverse sheet-conveying route 24, so that the image formed surface of the sheet P faces downward by conveying the sheet P from reverse sheet-conveying route 24 to the main sheet-conveying route 23. This enables the sheet P to be reversed, thereby allowing the image to be formed on the other upward surface of the sheet P.

The fixing portion 30 is an example of fixing members and performs fixing on the sheet P, to which the image has been transferred, to fix the image formed on the sheet P. The fixing portion 30 is provided with a pair of fixing rollers 31 and 32, which are contacted to each other with any pressure. The fixing portion 30 conveys the sheet P and performs any pressure fixing on the sheet P by the fixing rollers 31 and 32 and any heat fixing on the sheet P by a fixing heater 33 to fix the image on the sheet P.

The document-reading device 40 scans and exposes an image on the document using an optical system of a scanning and exposing device. The document-reading device 40 reads reflected right by its line image sensor to obtain an image signal. It is to be noted that in the image-forming apparatus 1A, an automatic document feeder, not shown, for automatically feeding the documents may be mounted on an upper portion thereof.

### <Configuration Example of Image-Forming System According to Embodiment of the Invention>

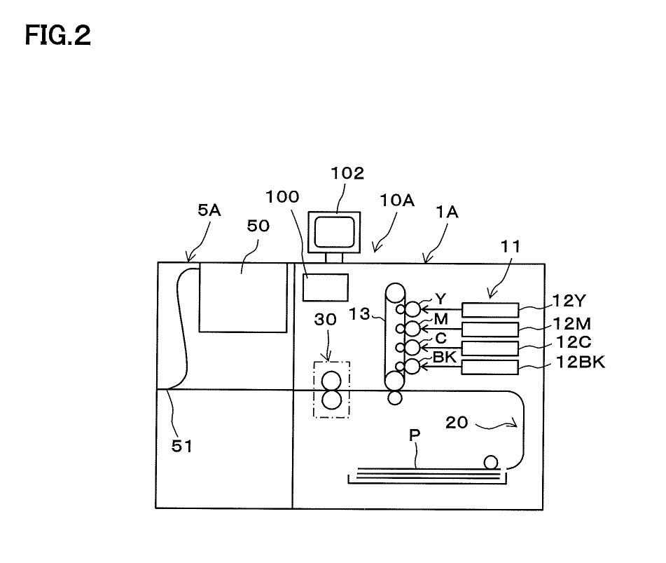

FIG. 2 shows a configuration example of an image-forming system according to an embodiment of this invention. The image-forming system 10A according to the embodiment of this invention is provided with the above-mentioned image-forming apparatus 1A that forms an image on a sheet, a processing device that receives the sheet from the image-forming apparatus 1A or sends the sheet to the image-forming apparatus 1A, a manipulation portion that executes an authentication operation by a user, and a hardware processor that determines whether or not a user manipulation is generated when a registered job is executing. The hardware processor requests the authentication operation by the user and allows the manipulation portion to execute the authentication operation by the user when the hardware processor determines that a job is the job in which a user manipulation is generated. The hardware processor executes the job when the authentication operation by the user is executed. The hardware processor waits for the execution of the job when the authentication operation by the user is not executed. The image-forming system 10A is also provided with a sheet-inserting portion 5A, as the processing device, which inserts a sheet to the sheets ejected from the image-forming apparatus 1A.

The sheet-inserting portion 5A is referred to as a “post-inserter”. The sheet-inserting portion 5A feeds any of the sheets contained in an insert-sheet-feeding tray 50 and inserts this sheet into the sheets ejected from the image-forming apparatus 1A and conveyed on a sheet-inserting-and-conveying route 51. It is to be noted that the image-forming system 10A may have such a configuration that it is provided with another post-processing apparatus like a sheet-binding apparatus which binds the sheets. The image-forming system 10A may also have such a configuration that it is provided with a feeding device which can contain a larger volume of sheets than those contained in any of the feeding trays 21 of the image-forming apparatus 1A.

### <Control Function Example of Image-Forming Apparatus and Image-Forming System According to Embodiment of the Invention>

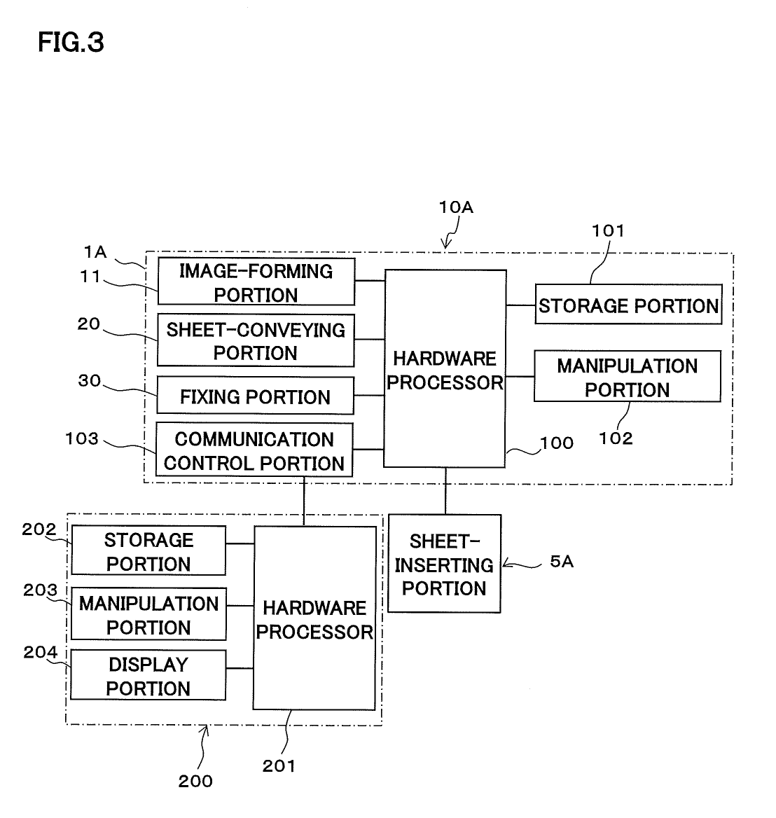

FIG. 3 shows a control function example of the image-forming apparatus 1A and the image-forming system 10A according to an embodiment of the invention. The following will describe a control function on an operation to determine whether or not a user manipulation is generated when a registered job is executing, and to start the job at the execution of the authentication operation by the user when determining that a job is the job in which a user manipulation is generated.

The image-forming apparatus 1A includes a hardware processor 100 that controls the image-forming apparatus 1A and other device such as the sheet-inserting portion 5A, which constitute the image-forming system 10A, to enable a series of operations from the feeding of the sheet P to the ejection of the sheet P through the image formation. The image-forming apparatus 1A also includes a storage portion 101 and a manipulation portion 102. The storage portion 101 stores a printer driver and the like, such as a program for executing a job about an image-forming process based on the setting of the job, a program for executing an authentication operation by a user based on the setting of the job, and the like. The manipulation portion 102 allows the user to set the job, to operate the printing and to execute the authentication operation.

The hardware processor 100 is provided with a micro processor, such as CPU or MPU.

The hardware processor 100 controls the sheet-conveying portion 20 in the image-forming apparatus 1A to convey the sheet P. The hardware processor 100 also controls the image-forming portion 11 to form the image on the sheet P based on image data. The hardware processor 100 further controls the fixing portion 3 to fix the image on the sheet P and to eject the sheet P on which the image is formed. Additionally, in the configuration in which the sheet-inserting portion 5A is provided, the hardware processor 100 controls a feed of sheets contained in the insert-sheet-feeding tray 50 and an insertion of the sheet into the sheets ejected from the image-forming apparatus 1A and conveyed on the sheet-inserting-and-conveying route 51.

The storage portion 101 is provided with a memory such as RAM, ROM and the like. The manipulation portion 102 is provided with a flat panel display such as a liquid crystal display as the display means and a touch panel, a key board or the like as an input means.

### <Control Function Example of Information-Processing Device According to Embodiment of the Invention>

An information-processing device 200 such as a personal computer by which the job is set is connected with the image-forming apparatus 1A of the image-forming system 10A through a communication control portion 103.

The information-processing device 200 includes a hardware processor 201 that controls the image-forming apparatus 1A and other device such as the sheet-inserting portion 5A, which constitute the image-forming system 10A, to enable a series of operations from the feeding of the sheet P to the ejection of the sheet P through the image formation.

The information-processing device 200 includes a storage portion 202, a manipulation portion 203 and a display portion 204. The storage portion 202 stores a printer driver and the like, such as a program for executing a job about an image-forming process based on the setting of the job, a program for executing an authentication operation by a user based on the setting of the job, and the like. The manipulation portion 203 allows the user to set the job, to operate the printing and to execute the authentication operation. The display portion 204 displays any manipulation screens for setting the job(s), operating the printing, executing the authentication operation and the like.

The hardware processor 201 is provided with a micro processor, such as CPU or MPU. The storage portion 202 is provided with a memory such as RAM, ROM and the like. The manipulation portion 203 is provided with a key board or the like. The display portion 204 is provided with a flat panel display such as a liquid crystal display. The hardware processor 201 determines whether or not a user manipulation is generated when a registered job is executing. The hardware processor 201 requests the authentication operation by the user and allows the manipulation portion 203 to execute the authentication operation by the user when the hardware processor 201 determines that a job is the job in which the user manipulation is generated. The hardware processor 201 executes the job when the authentication operation by the user is executed. The hardware processor 201 waits the job when the authentication operation by the user is not executed.

### <Example of Program for Executing Authentication Operation by User According to Embodiment of the Invention>

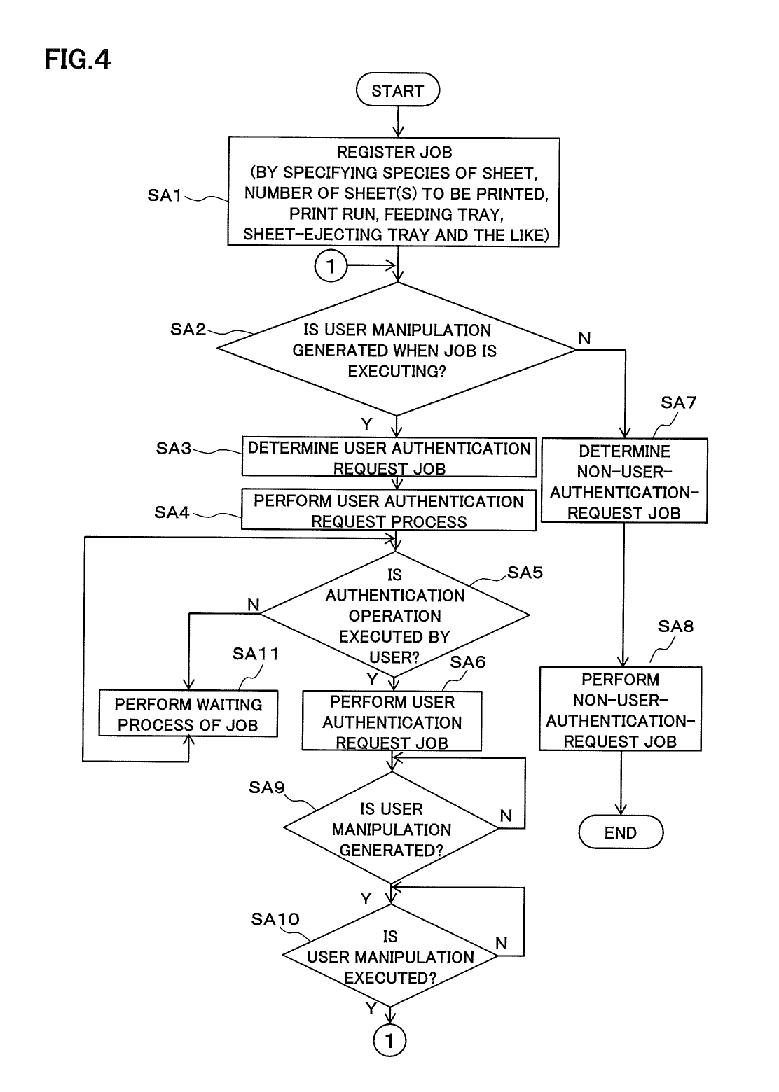

FIG. 4 shows an example of a program for executing the authentication operation by the user according to an embodiment of this invention. The following will describe an example of the program for the hardware processor 100 of the image-forming apparatus 1A or the hardware processor 201 of the information-processing device 200 to execute the authentication operation by the user.

In the program to execute the authentication operation by the user, at a step, SA1 of FIG. 4, by operation of the manipulation portion 102 of the image-forming apparatus 1A or the manipulation portion 203 of the information-processing device 200, a job is registered by specifying species of sheet, a number of the sheet(s) to be printed, a print run, a feeding tray, a sheet-ejecting tray and the like. At a step, SA2 of FIG. 4, the hardware processor 100 or 201 then determines whether or not a user manipulation is generated when the registered job is executing.

At a step, SA3 of FIG. 4, when determining that the registered job is the job in which the user manipulation is generated, the hardware processor 100 or 201 determines that this job is a job requesting an authentication operation by a user (a user authentication request job). At a step, SA4 of FIG. 4, the hardware processor 100 or 201 then performs a user authentication request process for requesting the authentication operation by the user and allowing the manipulation portion 102 of the image-forming apparatus 1A to execute the predetermined authentication operation by the user.

In the user authentication request process, the manipulation portion 102 or the like may display contents of the user manipulation which could be generated in addition to any words for conducting the authentication operation by the user.

When executing the authentication operation by the user in response to the user authentication request at a step, SA5 of FIG. 4, the hardware processor 100 or 201 executes a user authentication request job, at a step, SA6 of FIG. 4, as the executing process of the job. Further, in the user authentication request process, when specifying a user who registers the job and a user who performs the user authentication and they are the same user, the hardware processor 100 or 201 may determine that the user authentication has been executed. If at the step, SA2 of FIG. 4, the hardware processor 100 or 201 determines that a user manipulation is not generated when the registered job is executing, then the hardware processor 100 or 201 determines, at a step, SA7 of FIG. 4, that the job is a non-user-authentication-request job. The hardware processor 100 or 201 executes the non-user-authentication-request job, at a step, SA8 of FIG. 4, as the executing process of the job.

After the user authentication request job is executed at the step, SA6 of FIG. 4, if the hardware processor 100 or 201 determines that a user manipulation is generated at a step, SA9 of FIG. 4, the hardware processor 100 or 201 interrupts the job. At a step, SA10 of FIG. 4, the hardware processor 100 or 201 then determines whether or not the user manipulation is executed. If the hardware processor 100 or 201 determines that the user manipulation is executed, then the hardware processor 100 or 201 goes back to the step, SA2 where the hardware processor 100 or 201 determines whether or not a user manipulation is generated when the job is executing.

The hardware processor 100 or 201 determines whether or not a user manipulation is generated when the registered job is executing after the user manipulation is executed. If the hardware processor 100 or 201 determines that the user manipulation is generated when the restarted job is executing, then the hardware processor 100 or 201 determines that this job is a job requiring an authentication operation by a user at the step SA3 and the hardware processor 100 or 201 performs a user authentication request process for requesting the authentication operation by the user and allowing the manipulation portion 102 of the image-forming apparatus 1A to execute the predetermined authentication operation by the user at the step, SA4 of FIG. 4. This enables the user to know that there is a second user manipulation or later.

On the other hand, if the hardware processor 100 or 201 determines that the user manipulation is not generated when the restarted job is executing after the user manipulation at the step, SA2, then the hardware processor 100 or 201 restarts the job without requesting the authentication operation by the user at the steps, SA7 and SA8.

In a case where the authentication operation by the user is not executed in response to the user authentication request at the step, SA5 of FIG. 4, the hardware processor 100 or 201 waits without executing the user authentication request job, at a step, SA11 of FIG. 4, as the waiting process of the job. Further, in the waiting process of the job, the hardware processor 100 or 201 may determine whether or not there is another non-user-authentication-request job as the registered job. If the hardware processor 100 or 201 determines that there is another non-user-authentication-request job, then the hardware processor 100 or 201 may execute this non-user-authentication-request job.

### <Example of Operations in Information-Processing Device According to Embodiment of the Invention>

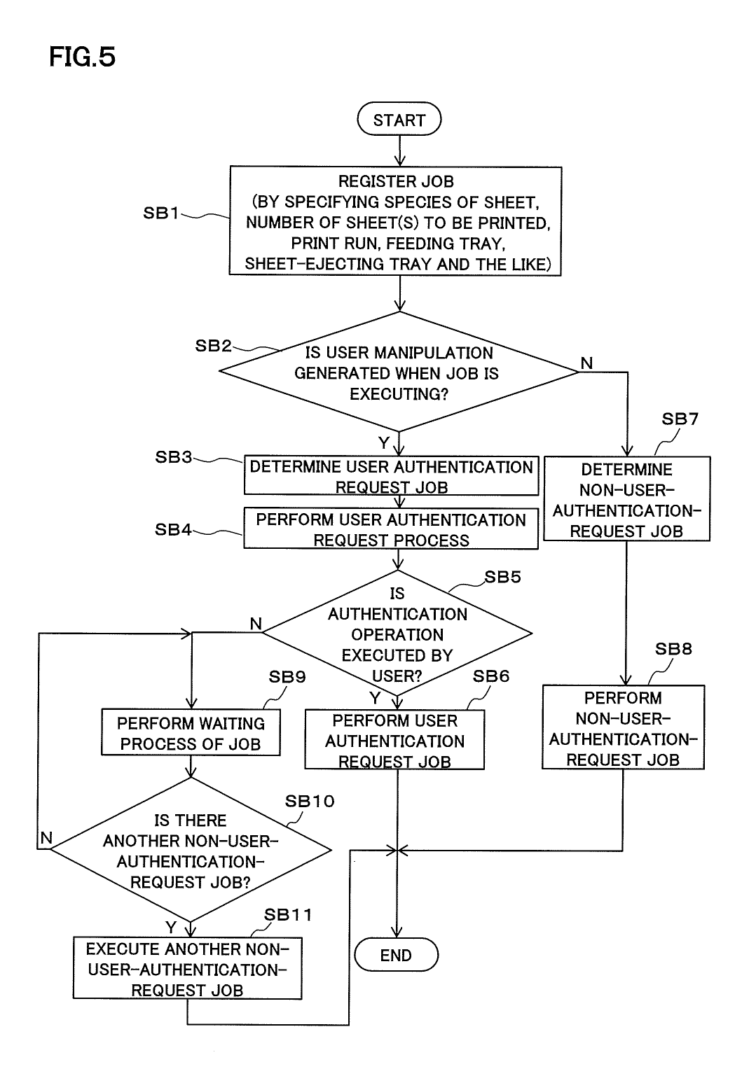

FIG. 5 shows an example of operations in the information-processing device 200 according to an embodiment of the invention. The following will describe a user authentication control to be executed in the information-processing device 200.

At a step, SB1 of FIG. 5, by operation of the manipulation portion 203, a job is registered by specifying species of sheet, a number of the sheet(s) to be printed, a print run, a feeding tray, a sheet-ejecting tray and the like. At a step, SB2 of FIG. 5, the hardware processor 201 of the information-processing device 200 then determines whether or not a user manipulation is generated when the registered job is executing by the program for executing the above-mentioned user authentication control.

At a step, SB3 of FIG. 5, when determining that the registered job is the job in which the user manipulation is generated, the hardware processor 201 determines that this job is a job requesting an authentication operation by a user (a user authentication request job). At a step, SB4 of FIG. 5, the hardware processor 201 then performs a user authentication request process for requesting the authentication operation by the user and allowing the manipulation portion 102 of the image-forming apparatus 1A to execute the predetermined authentication operation by the user.

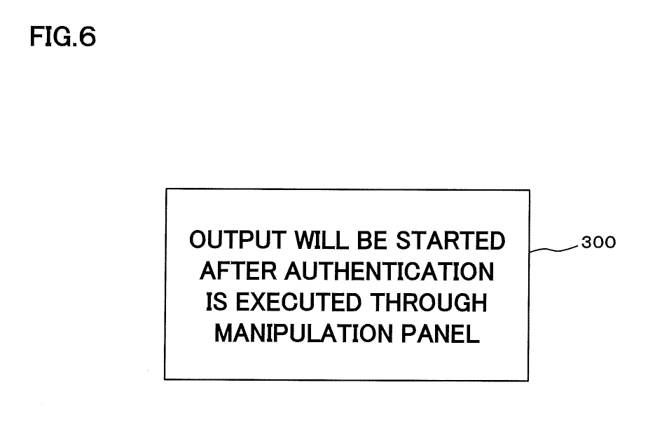

FIG. 6 shows an example of a user authentication request screen 300. In the user authentication request screen 300 displayed when the information-processing device 200 performs the user authentication request process, words indicating that the job will be executed after the authentication process is executed in the manipulation panel, which is the manipulation portion 102 of the image-forming apparatus 1A, are displayed.

This enables the user who manipulates the information-processing device 200 to know that a user manipulation is necessary when his registered job is executing. By moving him to an installed location of the image-forming apparatus 1A to perform the user authentication operation using the manipulation portion 102, he can wait following the user manipulation.

When the manipulation portion 102 of the image-forming apparatus 1A executes the authentication operation by the user in response to the user authentication request at a step, SB5 of FIG. 5, the hardware processor 201 controls the image-forming apparatus 1A or the image-forming system 10A including the image-forming apparatus 1A to execute a user authentication request job, at a step, SB6 of FIG. 5. If at the step, SB2 of FIG. 5, the hardware processor 201 determines that a user manipulation is not generated when the registered job is executing, then the hardware processor 201 determines, at a step, SB7 of FIG. 5, that the job is a non-user-authentication-request job. The hardware processor 201 executes the non-user-authentication-request job, at a step, SB8 of FIG. 5.

In a case where the authentication operation by the user is not executed in response to the user authentication request at the step, SB5 of FIG. 5, the hardware processor 201 waits without executing the user authentication request job, at a step, SB9 of FIG. 5, as the waiting process of the job in the image-forming apparatus 1A or the image-forming system 10A including the image-forming apparatus 1A. Further, in the waiting process of the job, at a step, SB10 of FIG. 5, the hardware processor 201 determine whether or not there is another non-user-authentication-request job as the registered job. If the hardware processor 201 determines that there is another non-user-authentication-request job, then the hardware processor 201 executes this non-user-authentication-request job at a step, SB11 of FIG. 5.

### <Example of Operations in Image-Forming Apparatus According to Embodiment of the Invention>

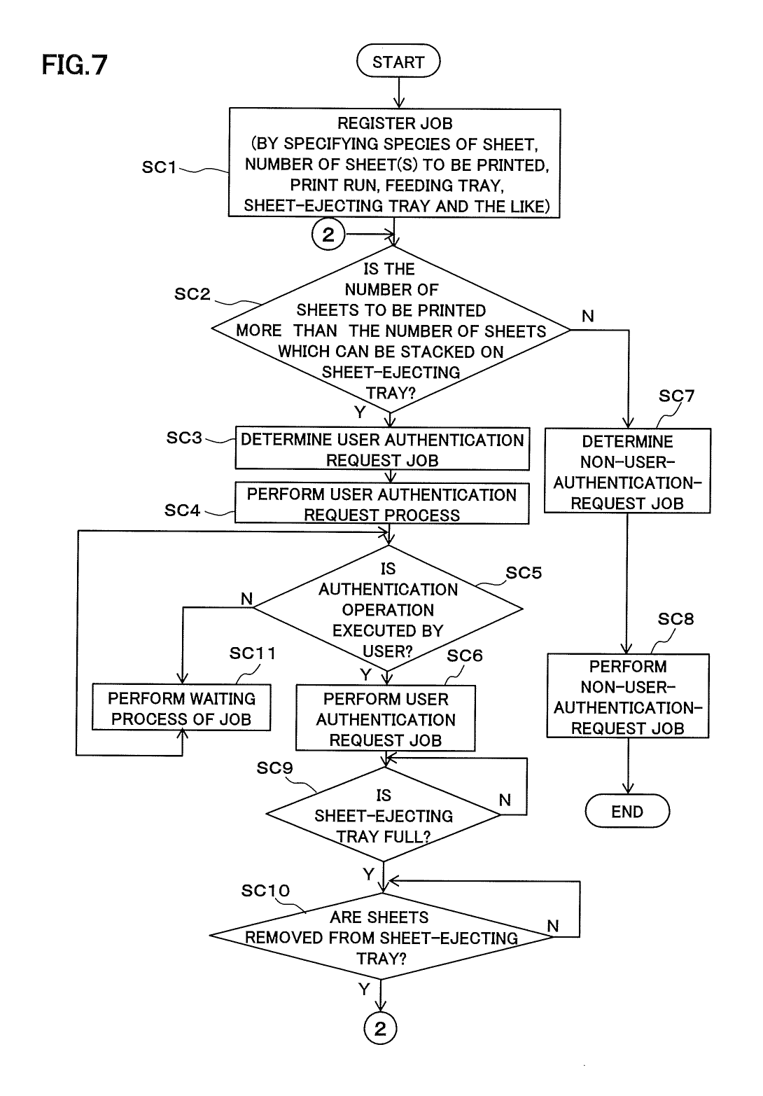

FIG. 7 shows an example of operations in the image-forming apparatus 1A. The following will describe a user authentication control to be executed in the image-forming apparatus 1A.

At a step, SC1 of FIG. 7, by operation of the manipulation portion 102, a job is registered by specifying species of sheet, a number of the sheet(s) to be printed, a print run, a feeding tray, a sheet-ejecting tray and the like. At a step, SC2 of FIG. 7, the hardware processor 100 of the image-forming apparatus 1A then determines whether or not a user manipulation is generated when the registered job is executing by the program for executing the above-mentioned user authentication control.

In a setting of the registered job by the operation of the manipulation portion 102 where the number of sheets to be printed is more than the number of sheets which can be stacked on the sheet-ejecting tray 25, a manipulation to remove the sheets stacked on the sheet-ejecting tray 25 is necessary when the job is executing. For example, when a job to print 2000 sheets is registered in contrast with the sheet-ejecting tray 25 on which at most 1000 sheets can be stacked, the manipulation for removing the sheets from the sheet-ejecting tray 25 is necessary.

The sheet-ejecting tray 25 is provided with a sheet-ejecting tray sensor 25a that detects that the sheets stacked on the sheet-ejecting tray 25 reach a maximum number of stackable sheets. This sensor is called as “sheet-ejecting tray full of sheet”. When the sheet-ejecting tray sensor 25a detects that the sheets stacked on the sheet-ejecting tray 25 reach a maximum number of stackable sheets, the job has been interrupted and after the sheets has been removed from the sheet-ejecting tray 25, the job has restarted. Therefore, when a user is away from the installed location of the image-forming apparatus 1A, the job has been interrupted.

On this embodiment, in a setting of the registered job by the operation of the manipulation portion 102 where the number of sheets to be printed is more than the number of sheets which can be stacked on the sheet-ejecting tray 25, the hardware processor 100 determines that the registered job is the job in which the user manipulation is generated. The hardware processor 100 of the mage-forming apparatus 1A acquires information on the number of sheets which can be stacked on the sheet-ejecting tray 25 and compares the number of sheets to be printed from the registered job with the number of sheets which can be stacked on the sheet-ejecting tray 25 to determine whether or not the registered job is the job in which the user manipulation is generated.

At a step, SC3 of FIG. 7, when determining that the registered job is the job in which the user manipulation is generated at the step, SC2, the hardware processor 100 determines that this job is a job requesting an authentication operation by a user (a user authentication request job). At a step, SC4 of FIG. 7, the hardware processor 100 then performs a user authentication request process for requesting the authentication operation by the user and allowing the manipulation portion 102 of the image-forming apparatus 1A to execute the predetermined authentication operation by the user.

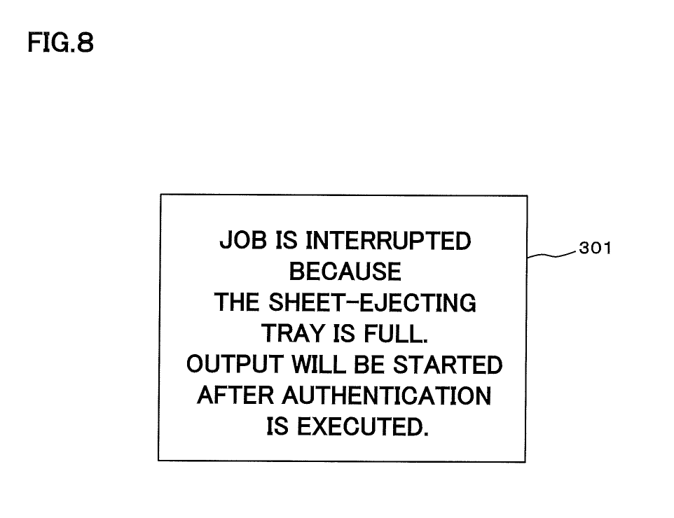

FIG. 8 shows an example of a user authentication request screen 301. In the user authentication request screen 301 displayed when the image-forming apparatus 1A performs the user authentication request process, words indicating that the job is interrupted because the sheet-ejecting tray is full and the job will be executed after the authentication process is executed in the manipulation portion 102 of the image-forming apparatus 1A, are displayed.

This enables the user who manipulates the image-forming apparatus 1A to know that a user manipulation is necessary when his registered job is executing and the content of the user manipulation is a removal of the sheets from the sheet-ejecting tray 25 in this embodiment. By executing the user authentication operation by the manipulation portion 102, the hardware processor 100 can wait following the user manipulation.

When the manipulation portion 102 executes the authentication operation by the user in response to the user authentication request at a step, SC5 of FIG. 7, the hardware processor 100 controls the image-forming apparatus 1A or the image-forming system 10A including the image-forming apparatus 1A to execute a user authentication request job, at a step, SC6 of FIG. 7. If at the step, SC2 of FIG. 7, the hardware processor 100 determines that a user manipulation is not generated when the registered job is executing, then the hardware processor 100 determines, at a step, SC7 of FIG. 7, that the job is a non-user-authentication-request job. The hardware processor 100 executes the non-user-authentication-request job, at a step, SC8 of FIG. 7.

After the user authentication request job is executed at the step, SC6 of FIG. 7, if the hardware processor 100 determines that a user manipulation is generated because the sheet-ejecting tray is full at a step, SC9 of FIG. 7, the hardware processor 100 interrupts the job. At a step, SC10 of FIG. 7, the hardware processor 100 then determines whether or not the user manipulation such that the sheets are removed from the sheet-ejecting tray 25 is executed. If the hardware processor 100 determines that the user manipulation is executed, then the hardware processor 100 goes back to the step, SC2 where the hardware processor 100 determines whether or not a user manipulation is generated when the job is executing.

The hardware processor 100 determines whether or not a user manipulation is generated when the restarted job is executing after the user manipulation is executed. If the hardware processor 100 determines that the user manipulation is generated when the restarted job is executing at the step, SC2, then the hardware processor 100 determines that this job is a job requiring an authentication operation by a user at the step SC3 and the hardware processor 100 performs a user authentication request process for requesting the authentication operation by the user and allowing the manipulation portion 102 of the image-forming apparatus 1A to execute the predetermined authentication operation by the user at the step, SC4 of FIG. 7. This enables the user to know that there is a second user manipulation or later.

On the other hand, if the hardware processor 100 determines that the user manipulation is not generated when the restarted job is executing after the user manipulation is executed at the step, SC2, then the hardware processor 100 restarts the job without requesting the authentication operation by the user at the steps, SC7 and SC8.

For example, when a job to print 3000 sheets is registered in contrast with the sheet-ejecting tray 25 on which at most 1000 sheets can be stacked, the two manipulations for removing the sheets from the sheet-ejecting tray 25 are necessary. Thus, the user manipulations are generated when the job is executing. Accordingly, if the hardware processor 100 determines that the user manipulations are generated when the job is executing, then the 100 interrupts the job because the sheet-ejecting tray is full and requests the authentication operation shown in FIG. 8 by the user when the user manipulates the removal of sheets from the sheet-ejecting tray 25. This enables the user to know that there is a second user manipulation or later.

In a case where the authentication operation by the user is not executed in response to the user authentication request at the step, SC5 of FIG. 7, the hardware processor 100 waits without executing the user authentication request job, at a step, SC11 of FIG. 7, as the waiting process of the job in the image-forming apparatus 1A or the image-forming system 10A including the image-forming apparatus 1A.

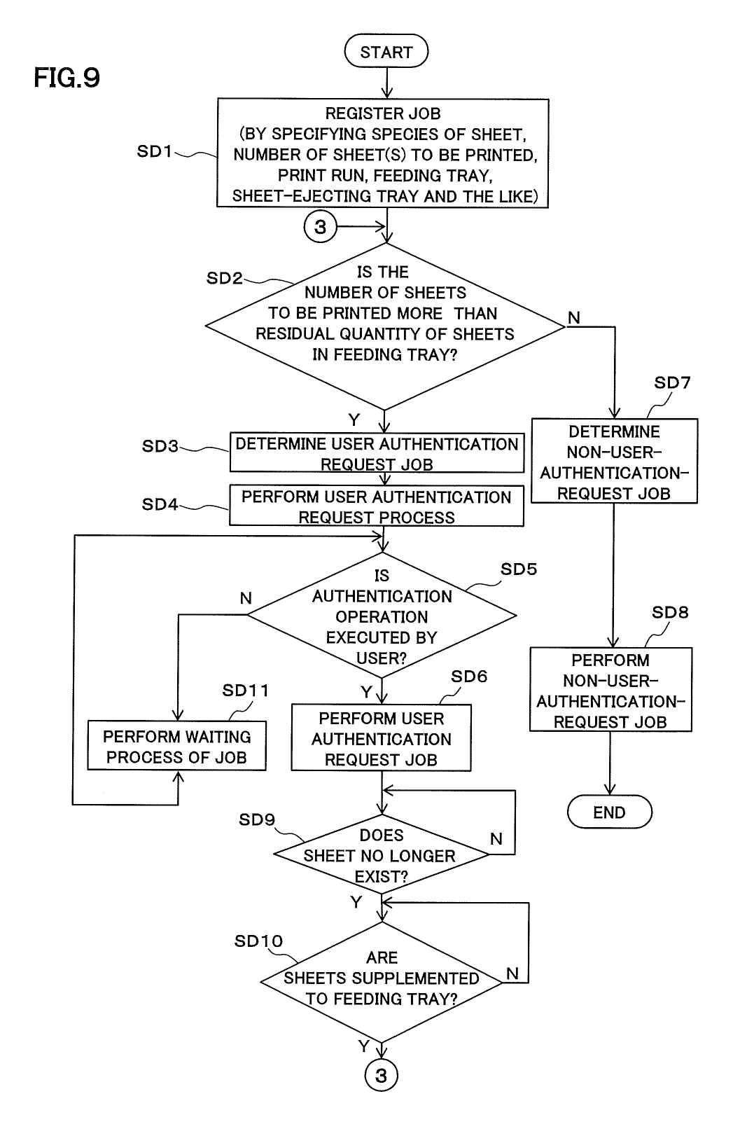

FIG. 9 shows another example of operations in an image-forming apparatus according to an embodiment of the invention. The following will describe a user authentication control to be executed in the image-forming apparatus 1A.

At a step, SD1 of FIG. 9, by operation of the manipulation portion 102, a job is registered by specifying species of sheet, a number of the sheet(s) to be printed, a print run, a feeding tray, a sheet-ejecting tray and the like. At a step, SD2 of FIG. 9, the hardware processor 100 of the image-forming apparatus 1A then determines whether or not a user manipulation is generated when the registered job is executing by the program for executing the above-mentioned user authentication control.

In a setting of the registered job by the operation of the manipulation portion 102 where the number of sheets to be printed is more than the number of sheets which can be contained in the feeding tray 21, a manipulation to supplement the sheets in the feeding tray 21 is necessary when the job is executing. For example, if a job to print 1000 sheets is registered when about 500 sheets remain in the feeding tray 21 in which at most 1000 sheets can be contained, the manipulation for supplementing the sheets to the feeding tray 21 is necessary.

The feeding tray 21 is provided with a feeding tray sensor 21b that detects the residual quantity of sheets based on a position of a tray board, not shown, on which the sheets are stacked. From output of the feeding tray sensor 21b, the hardware processor 100 roughly detects the residual quantity of sheets in the feeding tray 21 and detects that any sheet no longer exists. An icon may be used to roughly represent the residual quantity of sheets. For example, when the residual quantity of sheets is about 100%, four bars are represented; when the residual quantity of sheets is about 75%, three bars are represented; when the residual quantity of sheets is about 50%, two bars are represented; and when the residual quantity of sheets is about 25%, one bar is represented.

When the feeding tray sensor 21b detects that the sheet contained in the feeding tray 21 no longer exists, the job has been interrupted and after the sheets has been supplemented to the feeding tray 21, the job has restarted. Therefore, when a user is away from the installed location of the image-forming apparatus 1A, the job has been interrupted.

On this embodiment, in a setting of the registered job by the operation of the manipulation portion 102 where the number of sheets to be printed is more than the number of sheets which are contained in the feeding tray 21, the hardware processor 100 determines that the registered job is the job in which the user manipulation is generated. The hardware processor 100 of the mage-forming apparatus 1A acquires information on the residual quantity of the sheets in the feeding tray 21 and compares the number of sheets to be printed from the registered job with the residual quantity of the sheets in the feeding tray 21 to determine whether or not the registered job is the job in which the user manipulation is generated.

At a step, SD3 of FIG. 9, when determining that the registered job is the job in which the user manipulation is generated at the step, SD2, the hardware processor 100 determines that this job is a job requesting an authentication operation by a user (a user authentication request job). At a step, SD4 of FIG. 9, the hardware processor 100 then performs a user authentication request process for requesting the authentication operation by the user and allowing the manipulation portion 102 of the image-forming apparatus 1A to execute the predetermined authentication operation by the user.

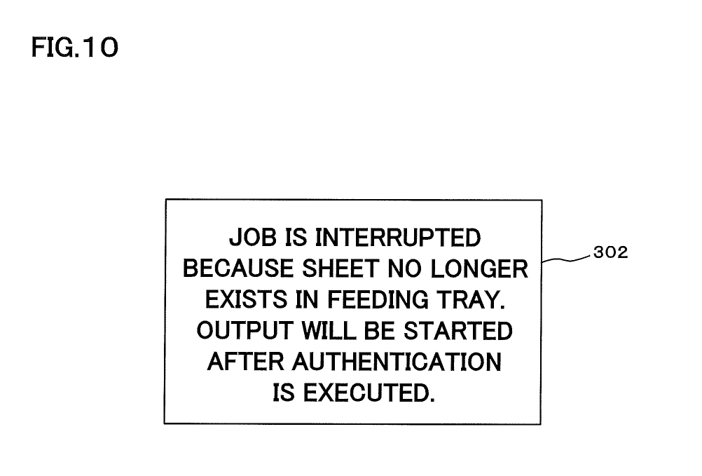

FIG. 10 shows an example of a user authentication request screen 302. In the user authentication request screen 302 displayed when the image-forming apparatus 1A performs the user authentication request process, words indicating that the job is interrupted because the sheet no longer exists and the job will be executed after the authentication process is executed in the manipulation portion 102 of the image-forming apparatus 1A, are displayed.

This enables the user who manipulates the image-forming apparatus 1A to know that a user manipulation is necessary when his registered job is executing and the content of the user manipulation is a supplement of the sheets to the feeding tray 21 in this embodiment. By executing the user authentication operation by the manipulation portion 102, the hardware processor 100 can wait following the user manipulation.

When the manipulation portion 102 executes the authentication operation by the user in response to the user authentication request at a step, SD5 of FIG. 9, the hardware processor 100 controls the image-forming apparatus 1A or the image-forming system 10A including the image-forming apparatus 1A to execute a user authentication request job, at a step, SD6 of FIG. 9. If at the step, SD2 of FIG. 9, the hardware processor 100 determines that a user manipulation is not generated when the registered job is executing, then the hardware processor 100 determines, at a step, SD7 of FIG. 9, that the job is a non-user-authentication-request job. The hardware processor 100 executes the non-user-authentication-request job, at a step, SD8 of FIG. 9.

After the user authentication request job is executed at the step, SD6 of FIG. 9, if the hardware processor 100 determines that a user manipulation is generated because the sheet no longer exists in the feeding tray 21, in this embodiment, at a step, SD9 of FIG. 9, the hardware processor 100 interrupts the job. At a step, SD10 of FIG. 9, the hardware processor 100 then determines whether or not the user manipulation to supplement the sheets to the feeding tray 21 is executed. If the hardware processor 100 determines that the user manipulation is executed at the step, SD10, then the hardware processor 100 goes back to the step, SD2 where the hardware processor 100 determines whether or not a user manipulation is generated when the job is executing.

The hardware processor 100 determines whether or not a user manipulation is generated when the restarted job is executing after the user manipulation is executed. If the hardware processor 100 determines that the user manipulation is generated when the restarted job is executing at the step, SD2, then the hardware processor 100 determines that this job is a job requiring an authentication operation by a user at the step SD3 and the hardware processor 100 performs a user authentication request process for requesting the authentication operation by the user and allowing the manipulation portion 102 of the image-forming apparatus 1A to execute the predetermined authentication operation by the user at the step, SD4 of FIG. 9. This enables the user to know that there is a second user manipulation or later.

On the other hand, if the hardware processor 100 determines that the user manipulation is not generated when the restarted job is executing after the user manipulation is executed at the step, SD2, then the hardware processor 100 restarts the job without requesting the authentication operation by the user at the steps, SD7 and SD8 of FIG. 9.

For example, when a job to print 3000 sheets is registered in contrast with the feeding tray 21 in which at most 1000 sheets can be contained, the two manipulations or more for supplementing the sheets to the feeding tray 21 are necessary on the basis of the residual quantity of the sheets. Thus, the user manipulations are generated when the job is executing. Accordingly, if the hardware processor 100 determines that the user manipulations are generated when the job is executing, then the hardware processor 100 interrupts the job because the sheet no longer exists in the feeding tray 21 and requests the authentication operation shown in FIG. 10 by the user when the user manipulates the supplement of sheets to the feeding tray 21. This enables the user to know that there is a second user manipulation or later.

In a case where the authentication operation by the user is not executed in response to the user authentication request at the step, SD5 of FIG. 9, the hardware processor 100 waits without executing the user authentication request job, at a step, SD11 of FIG. 9, as the waiting process of the job in the image-forming apparatus 1A or the image-forming system 10A including the image-forming apparatus 1A.

It is to be noted that although the hardware processor 100 has determined whether or not a job is the job in which the user manipulation is generated on the basis of the residual quantity of the sheets in the feeding tray 21 of the image-forming apparatus 1A in this example, it is possible to determine whether or not a job is the job in which the user manipulation is generated on the basis of the residual quantity of the sheets in the feeding tray of an external feeder constituting the image-forming system.

### <Example of Operations in Image-Forming System According to Embodiment of the Invention>

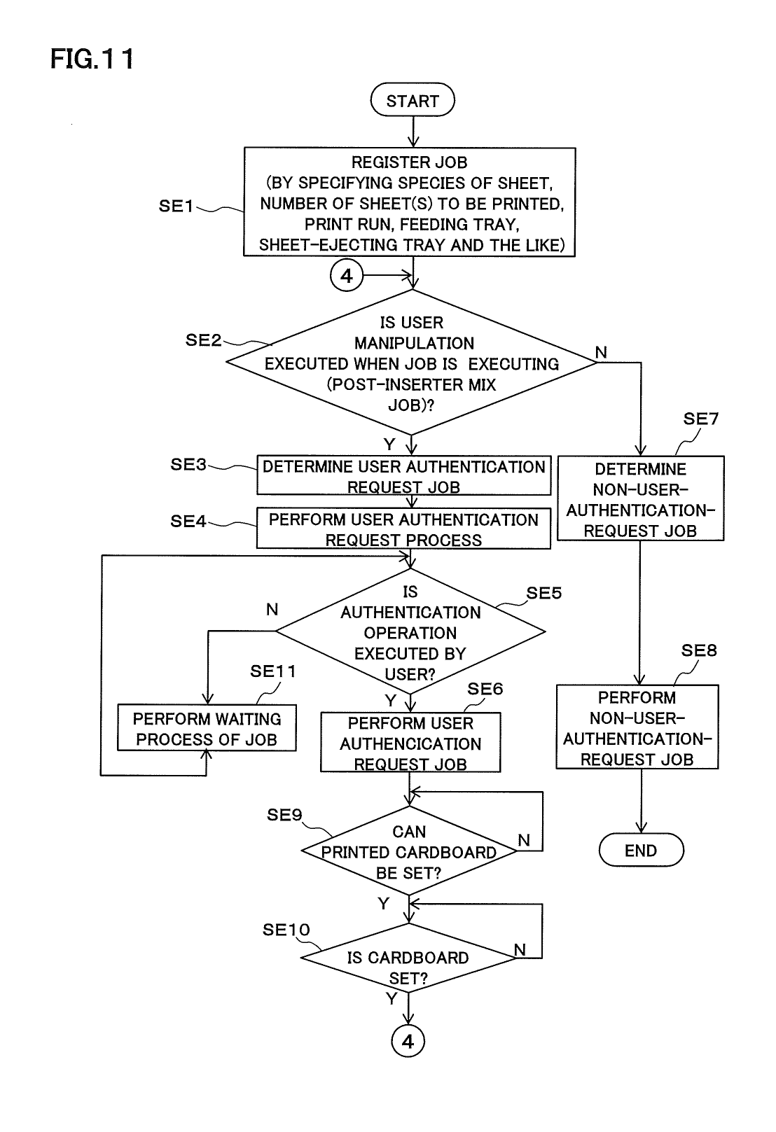

FIG. 11 shows an example of operations in an image-forming system 10A according to an embodiment of the invention. The following will describe a user authentication control to be executed in the image-forming system 10A.

When printing plural sets of a document in which regular sheets and cardboards are mixed, a waiting time for exchanging electrophotographic processes such as conveying speed, fixing temperature and the like is generated because the electrophotographic processes for the regular sheet and the cardboard are different from each other. In order to suppress the waiting time for exchanging the electrophotographic processes, the image-forming apparatus 1A previously prints only the cardboards in the image-forming system 10A shown in FIG. 2. The printed cardboards are set in the insert-sheet-feeding tray 50 of the sheet-inserting portion 5A. The image-forming apparatus 1A then prints the regular sheets. The cardboards stacked on the insert-sheet-feeding tray 50 are fed out thereof and the printed regular sheets are ejected from image-forming apparatus 1A and conveyed on the sheet-inserting-and-conveying route 51. The printed cardboards are inserted into the printed regular sheets conveyed on the sheet-inserting-and-conveying route 51.

It is possible to decrease hours of operated time in the image-forming system 10A including the sheet-inserting portion 5A because the number of the electrophotographic process exchanging is reduced. However, a user manipulation to set the printed cardboards in the sheet-inserting portion 5A is generated.

Accordingly, at a step, SE1 of FIG. 11, by operation of the manipulation portion 102, a job is registered by specifying species of sheet, a number of the sheet(s) to be printed, a print run, a feeding tray, a sheet-ejecting tray and the like. At a step, SE2 of FIG. 11, the hardware processor 100 of the image-forming apparatus 1A then determines whether or not a job is a sheet-inserting job (referred to as “a post-inserter mix job”) in which a user manipulation is generated when the registered job is executing by the program for executing the above-mentioned user authentication control.

At a step, SE3 of FIG. 11, when determining that the registered job is the sheet-inserting job in which the user manipulation is generated at the step, SE2, the hardware processor 100 determines that this job is a job requesting an authentication operation by a user (a user authentication request job). At a step, SE4 of FIG. 11, the hardware processor 100 then performs a user authentication request process for requesting the authentication operation by the user and allowing the manipulation portion 102 of the image-forming apparatus 1A to execute the predetermined authentication operation by the user.

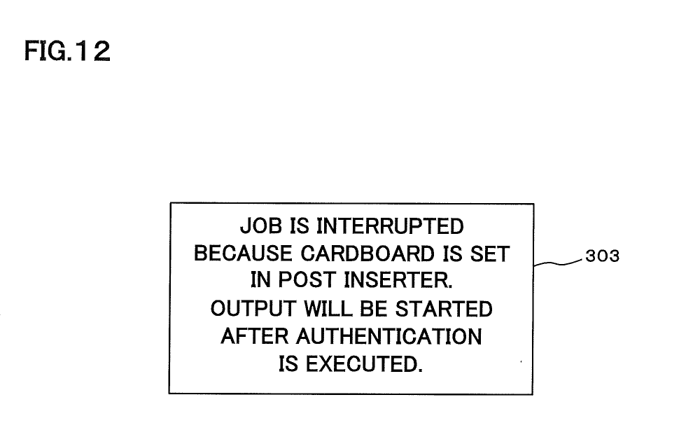

FIG. 12 shows an example of a user authentication request screen 303. In the user authentication request screen 303 displayed when the image-forming system 10A performs the user authentication request process, words indicating that the job is interrupted because the sheet is reset in the sheet-inserting portion 5A and the job will be executed after the authentication process is executed in the manipulation portion 102 of the image-forming apparatus 1A, are displayed.

This enables the user who manipulates the image-forming apparatus 1A to know that a user manipulation is necessary when his registered job is executing and the content of the user manipulation is the resetting of the sheets to the sheet-inserting portion 5A in this embodiment. By executing the user authentication operation by the manipulation portion 102, the hardware processor 100 can wait following the user manipulation.

When the manipulation portion 102 executes the authentication operation by the user in response to the user authentication request at a step, SE5 of FIG. 11, the hardware processor 100 controls the image-forming system 10A to execute a user authentication request job, at a step, SE6 of FIG. 11. If at the step, SE2 of FIG. 11, the hardware processor 100 determines that a user manipulation is not generated when the registered job is executing, then the hardware processor 100 determines, at a step, SE7 of FIG. 11, that the job is a non-user-authentication-request job. The hardware processor 100 executes the non-user-authentication-request job, at a step, SE8 of FIG. 11.

After the user authentication request job is executed at the step, SE6 of FIG. 11, if the hardware processor 100 determines that a user manipulation is generated because the cardboards are printed and the printed cardboards are reset in the insert-sheet-feeding tray 50 of the sheet-inserting portion 5A, in this embodiment, at a step, SE9 of FIG. 11, the hardware processor 100 interrupts the job. At a step, SE10 of FIG. 11, the hardware processor 100 then determines whether or not the user manipulation to set the cardboards to the insert-sheet-feeding tray 50 is executed. If the hardware processor 100 determines that the user manipulation is executed at the step, SE10, then the hardware processor 100 goes back to the step, SE2 where the hardware processor 100 determines whether or not a user manipulation is generated when the job is executing.

The hardware processor 100 determines whether or not a user manipulation is generated when the restarted job is executing after the user manipulation is executed. If the hardware processor 100 determines that the user manipulation is generated when the restarted job is executing at the step, SE2, then the hardware processor 100 determines that this job is a job requiring an authentication operation by a user at the step SE3 and the hardware processor 100 performs a user authentication request process for requesting the authentication operation by the user and allowing the manipulation portion 102 of the image-forming apparatus 1A to execute the predetermined authentication operation by the user at the step, SE4 of FIG. 11. This enables the user to know that there is a second user manipulation or later.

On the other hand, if the hardware processor 100 determines that the user manipulation is not generated when the restarted job is executing after the user manipulation is executed at the step, SE2, then the hardware processor 100 restarts the job without requesting the authentication operation by the user at the steps, SE7 and SE8 of FIG. 11.

For example, when outputting a booklet using the sheets which are more than the number of the sheets that can be stacked on the insert-sheet-feeding tray 50, the two manipulations or more for supplementing the sheets to the insert-sheet-feeding tray 50 are necessary. The user manipulations are generated when the job is executing. Accordingly, if the hardware processor 100 determines that the user manipulations are generated when the job is executing, then the hardware processor 100 requests the authentication operation shown in FIG. 12 by the user at the user manipulation. This enables the user to know that there is a second user manipulation or later.

In a case where the authentication operation by the user is not executed in response to the user authentication request at the step, SE5 of FIG. 11, the hardware processor 100 waits without executing the user authentication request job, at a step, SE11 of FIG. 11, as the waiting process of the job in the image-forming apparatus 1A or the image-forming system 10A including the image-forming apparatus 1A.

It is to be noted that the jobs in each of which the user manipulation is generated when the job is executing are not limited to the above-mentioned embodiments or examples. For example, they may include a job to require removing the sheets from the sheet-ejecting tray 25, such as a job to print a long sheet, in spite of the number of the sheets which can be stacked on the sheet-ejecting tray 25, a job to feed the sheets from a sheet-feeding means such as an external feeding tray 26 on which a small number of the sheets can be stacked, and the like.

This invention is applicable to a printing system which includes an image-forming apparatus, a large volume feeder and various kinds of post-processing devices.

The terms and expressions which have been employed in the foregoing description are used therein as terms of description and not of limitation, and these are no intention, in the use of such terms and expressions, of excluding equivalent of the features shown and described or portions thereof, it being recognized that the scope of the invention is defined and limited only by the claims.

What is claimed is:

1. An image-forming apparatus comprising:
a feeder that feeds a sheet;
an image-forming portion that forms an image on the sheet fed from the feeder;
a fixing portion that fixes the image formed on the sheet by the image-forming portion;
a sheet-ejection portion that ejects the sheet on which the image is fixed by the fixing portion;
a manipulation portion that executes an authentication operation by a user; and
a hardware processor configured to perform the following process:
determining whether or not a user manipulation is generated when a job is executing;
requesting the authentication operation by the user and allowing the manipulation portion to execute the authentication operation by the user when determining that a job is the job in which the user manipulation is generated;
executing the job when the authentication operation by the user is executed; and
waiting for the execution of the job when the authentication operation by the user is not executed.

2. The image-forming apparatus according to claim 1 wherein when the user manipulation is generated while the job is executing, the hardware processor is configured to perform the following process:
determining whether or not the user manipulation is generated when the job is executing after the user manipulation is executed;
requesting the user authentication operation by the user and allowing the manipulation portion to execute the authentication operation by the user when determining that a job is the job in which the user manipulation is generated;
executing the job when the authentication operation by the user is executed;
waiting for the execution of the job when the authentication operation by the user is not executed; and
avoiding requesting the authentication operation by the user to execute the job when determining that a job is the job in which the user manipulation is not generated.

3. The image-forming apparatus according to claim 1 wherein when determining that the number of sheets to be printed, the number being set by the job, is more than the number of sheets which can be fed from the feeder, the hardware processor requests the authentication operation by the user before the execution of the job.

4. The image-forming apparatus according to claim 1 wherein when determining that the number of sheets to be printed, the number being set by the job, is more than the number of sheets which can be ejected by the sheet-ejection portion, the hardware processor requests the authentication operation by the user before the execution of the job.

5. The image-forming apparatus according to claim 1 further comprising a sheet-inserting portion that inserts a sheet to other sheets which are ejected from the sheet-ejection portion,
wherein when determining that an inserting job is executed, the hardware processor requests the authentication operation by the user before the execution of the inserting job, the inserting job including printing an inserting sheet, setting the printed inserting sheet in the sheet-inserting portion, printing sheets to which the inserting sheet is inserted, and inserting the inserting sheet to the sheets to which the inserting sheet is inserted.

6. The image-forming apparatus according to claim 1 wherein the hardware processor informs the user that the job is executed after the authentication operation by the user when requesting the authentication operation by the user.

7. An image-forming system comprising:
an image-forming portion that forms an image on a sheet;
a processing device that receives the sheet from the image-forming portion or sends the sheet to the image-forming portion;
a manipulation portion that executes an authentication operation by a user; and
a hardware processor configured to perform the following process:
determining whether or not a user manipulation is generated when a registered job is executing,
requesting the authentication operation by the user and allowing the manipulation portion to execute the authentication operation by the user when determining that a job is the job in which the user manipulation is generated;
executing the job when the authentication operation by the user is executed; and
waiting for the execution of the job when the authentication operation by the user is not executed.

8. The image-forming system according to claim 7 wherein the processing device includes a sheet-inserting portion that inserts a sheet to other sheets which are ejected from the image-forming portion,
wherein when determining that an inserting job is executed, the hardware processor requests the authentication operation by the user before the execution of the inserting job, the inserting job including printing an inserting sheet, setting the printed inserting sheet in the sheet-inserting portion, printing sheets to which the inserting sheet is inserted, and inserting the inserting sheet to the sheets to which the inserting sheet is inserted.

9. An information-processing device that is connected to an image-forming portion that forms an image on a sheet, the information-processing device comprising:
a manipulation portion that executes an authentication operation by a user; and
a hardware processor configured to perform the following process:
determining whether or not a user manipulation is generated when a registered job is executing;
requesting the authentication operation by the user and allowing the manipulation portion to execute the authentication operation by the user when determining that a job is the job in which the user manipulation is generated;
executing the job when the authentication operation by the user is executed; and
waiting for the execution of the job when the authentication operation by the user is not executed.

10. An image-forming method for executing a job relating to an image-forming process according to a program, the method comprising the steps of:
determining whether or not a user manipulation is generated when a registered job is executing;
requesting the authentication operation by the user and allowing a manipulation portion to execute an authentication operation by a user when determining that a job is the job in which the user manipulation is generated;
executing the registered job when the authentication operation by the user is executed; and
waiting for the execution of the job when the authentication operation by the user is not executed.
